(19) United States
(12) Patent Application Publication
(10) Pub. No.: US 2026/0279132 A1
(43) Pub. Date: Sep. 17, 2026

(54) PRIMARY LATCH MECHANISM FOR A BANKNOTE PROCESSING DEVICE

(71) Applicant: GIESECKE+DEVRIENT CURRENCY TECHNOLOGY GMBH, Munchen (DE)

(72) Inventors: Aashish BHATNAGAR, GURUGRAM HARYANA (IN); Shivam Shakti DUBEY, GURUGRAM HARYANA (IN)

(21) Appl. No.: 19/168,434

(22) PCT Filed: Mar. 26, 2024
(86) PCT No.: PCT/EP2024/025132

§ 371 Date: Sep. 24, 2025

(30) Foreign Application Priority Data
Mar. 27, 2023 (IN) 202311022148

(51) Int. Cl. G07D 11/40; F16B 1/04; F16B 2/18

(52) U.S. Cl. CPC G07D 11/40; F16B 1/04; F16B 2/18

(57) ABSTRACT

A primary latch mechanism for a banknote processing device includes a first latch component designed to engage with a second latch component. The first latch component features a lever arm with a recess and a guide surface. The second latch component includes an engagement pin and a guide pin. The recess can receive the engagement pin to lock the mechanism. The guide surface contacts the guide pin when the first latch component moves relative to the second latch component, allowing the guide surface to slide along the guide pin. This movement partially releases the engagement pin from the recess, enabling the latch to unlock.

### TECHNICAL FIELD

The disclosure generally relates to latch mechanisms for banknote processing devices. In particular, the invention relates to a primary latch mechanism for a banknote processing device and a banknote processing device comprising said primary latch mechanism.

### TECHNICAL BACKGROUND

Banknote processing systems are employed in a variety of applications. For example, banknote processing systems may be present in the form of banknote stacking systems, banknote sorting systems, banknote singling systems, etc. During the processing operation, these systems may acquire information about the banknotes, for example via sensors. The sensors may collect the information while the banknotes are moved through the respective system. In particular, the banknotes may be sequentially moved on a transport path that guides the banknotes through the banknote processing system. Occasionally, it may happen that one or more banknotes are trapped or jammed at a certain position along the transport path, which may inhibit the further processing operation by the banknote processing system. In order to re-establish a proper functioning of the system, an operator might be required to manually open the transport path and remove possibly trapped or jammed banknotes. However, opening the transport path by manual interaction and providing access to the same usually requires the operator to disengage corresponding latches, which can sometimes be difficult or even exhausting.

### SUMMARY

It may be seen as an object of the invention to facilitate the maintenance of a banknote processing device.

A primary latch mechanism according to the features of the independent claim is provided. Further embodiments are evident from the dependent claims and from the following description.

According to an aspect, a primary latch mechanism for a banknote processing device is provided. The primary latch mechanism comprises a first latch component and a second latch component. The first latch component is configured to engage with the second latch component upon a movement of the first latch component relative to the second latch component. The first latch component comprises lever arm having a recess and a guide surface. The second latch component comprises an engagement pin and a guide pin. The recess is configured to receive the engagement pin, thereby providing a locked state of the primary latch mechanism in which the first latch component is engaged with the second latch component. The guide surface is configured to establish a contact with the guide pin upon a first partial movement of the first latch component relative to the second latch component. The guide surface is also configured to slide along the guide pin during a second partial movement of the first latch component relative to the second latch component such that the engagement pin is at least partially removed from the recess, thereby providing an unlocked state of the primary latch mechanism in which the first latch component is disengaged from the second latch component.

The inventive primary latch mechanism may be part of a banknote processing device, for example a banknote stacking device, a banknote sorting device, a banknote singling device or a banknote transport device. In particular, the primary latch mechanism may be configured to keep the banknote processing device in a locked state during the operation of the banknote processing device. In a closed state of the banknote processing device and thus in the locked state of the primary latch mechanism, the banknotes may be transported through a transport path within the banknote processing device while the locked primary latch mechanism maintains defined spaces and distances associated with the transport path such that one or more sensors arranged at the transport path can deliver accurate and reproducible information about the transported banknotes.

The inventive primary latch mechanism may allow an operator to open the banknote processing device easily and quickly, and particularly may facilitate unlocking of the banknote processing device to provide access to the interior of the banknote processing device and thus to the transport path. This may be achieved by an improved design of the primary latch mechanism which avoids mechanical couplings or linkages to any secondary latch mechanism of the banknote processing device. In other words, the primary latch mechanism can switch between a locked state and an unlocked state, independently of a configuration or state of any other latch mechanism of the banknote processing device.

In the locked state, the first latch component of the primary latch mechanism is engaged with the second latch component of the primary latch mechanism, wherein the engagement pin may be positioned within the recess of the lever arm to block any unintentional movement of the first latch component relative to the second latch component.

Starting from the locked state, the first latch component, in particular the lever arm of the first latch component, may be moved according to the first partial movement until the guide surface gets in contact with the guide pin. The lever arm may generally have a longitudinal extension and may comprise an enlarged head portion in which the recess is located. The guide surface may be an outer surface at the head portion of the lever arm that guides the movement of the lever arm during the second partial movement. In particular, the movement direction of the lever arm can be changed at a point in time when the guide surface gets in contact with the guide pin. This allows the lever arm including the recess to be urged away from the engagement pin, thereby unlocking the primary latch mechanism. The point in time when the guide surface gets in contact with the guide pin may define a transition from the first partial movement to the second partial movement of the first latch component, in particular the lever arm, relative to the second latch component. In the unlocked state, a third partial movement of the first latch component, in particular of the lever arm, may afterwards further separate the lever arm from the engagement pin, for example during an opening procedure of the banknote processing device in which the primary latch mechanism is integrated.

According to an embodiment, the engagement pin is movably arranged at the second latch component such that a distance between the engagement pin and the guide pin is reduced during the first partial movement of the first latch component relative to the second latch component.

The engagement pin and the guide bin may both be mounted to a carrier element, for example a plate-like structure or a frame-like structure. The engagement pin may be movably mounted on the carrier element, such that, during the first partial movement, the engagement pin is pulled by the lever arm closer to the guide pin. In other words, the movable arrangement of the engagement pin at the second latch component allows the lever arm to be pulled closer to the guide pin, thereby enabling the guide surface of the lever arm to establish the above-described contact to the guide pin. During the first partial movement, the engagement pin may still be at least partially arranged within the recess of the lever arm.

According to an embodiment, the guide pin is arranged relative to the guide surface such that a movement direction of the lever arm changes when the contact between the guide surface and the guide pin is established.

The movement direction of the lever arm may change such that the recess is separated from the engagement pin. In other words, the lever arm is urged away from the engagement pin to enable disengagement of the first latch component from the second latch component. In this manner the unlocked state of the primary latch mechanism can be achieved. Said unlocked state may be defined by the engagement pin being located at least partially outside or being located completely outside of the recess.

According to an embodiment, the lever arm is configured to move according to a first movement direction during the first partial movement of the first latch component relative to the second latch component and the lever arm is configured to move according to a second movement direction during the second partial movement of the first latch component relative to the second latch component, wherein the first movement direction differs from the second movement direction.

The first partial movement may be defined by a relatively short initial movement of the lever arm including the guide surface towards the guide pin, i.e., in the first movement direction. The second partial movement may be defined by a relatively longer subsequent movement of the lever arm including the recess away from the engagement pin, i.e., in the second movement direction. This second movement direction is determined by the orientation of the guide surface on the lever arm. In an example the first and second movement direction may enclose an obtuse angle. It is noted that the first partial movement may be defined by a movement between the first and second latch component which merely increases the pressure between the guide surface and the guide pin. That is, in the locked state, the first partial movement might not occur in the form of a perceivable translational movement, but rather in the form of a stronger pulling of the guide surface towards the guide pin.

According to an embodiment, the lever arm is rotatable about a rotational axis of the lever arm, wherein the lever arm is configured to rotate about the rotational axis of the lever arm during the second partial movement of the first latch component relative to the second latch component.

It is possible that the lever arm is moved in a substantially translational movement during the first partial movement until the guide surface contacts the guide pin, and then the lever arm is moved in a substantially rotational movement during the second partial movement until the engagement pin has been a least partially or completely removed from the recess.

According to an embodiment, the lever arm is configured slide along the engagement pin in a third movement direction during a third partial movement of the first latch component relative to the second latch component such that the recess is spatially separated from the engagement pin.

The third partial movement may be defined by a movement of the lever arm subsequent to the second partial movement, i.e., during the unlocked state of the primary latch mechanism. The third partial movement may thus pull the lever arm away from the engagement pin, which for instance is the case when opening the banknote processing device in which the primary latch mechanism can be integrated as described above.

According to an embodiment, the second latch component comprises a carrier element to which the engagement pin is movably coupled and/or to which the guide pin is fixedly coupled.

The carrier element may be a plate-like or frame-like structure that is coupled to or is part of a support structure of the banknote processing device. The lever arm may be moved relative to the carrier element when the first latch component is engaged with or disengaged from the second latch component.

According to an embodiment, the lever arm is translationally movable with respect to the carrier element of the second latch component and/or the lever arm is rotationally movable with respect to the carrier element of the second latch component.

During the first partial movement, the lever arm may be mainly moved with a translational movement and, during the second partial movement, the lever arm may be mainly moved with a rotational movement. During the third partial movement, the lever arm may be mainly moved with a translational movement again.

According to an embodiment, the primary latch mechanism further comprises a biasing element configured to maintain the locked state of the primary latch mechanism in which the first latch component is engaged with the second latch component.

The biasing element may be a spring, for example a coil spring, that couples the lever arm to a support structure of the banknote processing device. In an example, the biasing element is coupled to one end of the lever arm and the recess is arranged at another, opposite end of the lever arm.

According to an aspect, a banknote processing device is provided. The banknote processing device comprises the primary latch mechanism as described herein. Furthermore, the banknote processing device comprises a first support structure and a second support structure. The first support structure and the second support structure together define an internal space of the banknote processing device, wherein the first support structure and the second support structure are moveable relative to each other from a closed configuration to an opened configuration in order to allow access to the internal space of the banknote processing device. The first latch component of the primary latch mechanism is coupled to the first support structure and the second latch component of the primary latch mechanism is coupled to the second support structure.

The support structures may together define a base structure or corpus of the banknote processing device. The support structures may comprise frame components and/or housing components.

According to an embodiment, the first support structure and the second support structure are moveable relative to each other from the closed configuration to the opened configuration when the primary latch mechanism is in the unlocked state.

Said relative movement may be a pivot movement of the first support structure with respect to the second support structure. In the locked state of the primary latch mechanism, a movement of the first support structure relative to the second support structure may be blocked or inhibited since the first latch component which is coupled to the first support structure is engaged with the second latch component which is coupled to the second support structure.

According to an embodiment, the internal space defines a banknote transport path for banknotes processed by the banknote processing device.

In other words, the banknote transport path may define a free space within the banknote processing device that separates the first from the second support structure. The transport path may comprise conveyor means, such as rollers, arranged along the transport path, wherein the conveyor means are configured to sequentially move the banknotes through the banknote transport path.

According to an embodiment, the banknote processing device further comprises a first sensor arranged at the first support structure and a second sensor arranged at the second support structure.

These sensors and further sensors or sensor modules may be distributed along the banknote transport path. The sensors may be configured to acquire information about the banknotes moving through the banknote transport path.

According to an embodiment, the banknote processing device further comprises a secondary latch mechanism having a first latch component and a second latch component, wherein the first latch component of the secondary latch mechanism is coupled to the first support structure and the second latch component of the secondary latch mechanism is coupled to the second support structure.

Preferably, there may be no couplings or linkages that couple the secondary latch mechanism to the primary latch mechanism. In particular, no rods or bars may couple the lever arm of the primary latch mechanism to a lever arm of the secondary latch mechanism. Both latch mechanisms may thus be kinematically decoupled, which facilitates the unlocking of the primary latch mechanism and/or the secondary latch mechanism, thus making it easier and more comfortable for an operator to manually open the banknote processing device for maintenance purposes. This improves the entire maintenance process for the banknote processing device.

According to an embodiment, the first support structure and the second support structure are moveable relative to each other from the closed configuration to the opened configuration when the secondary latch mechanism is in an unlocked state.

That is, an opening procedure of the banknote processing device may be enabled when both the primary and the secondary latch mechanism are in their unlocked states.

### BRIEF DESCRIPTION OF THE DRAWINGS

The present invention will hereinafter be described in conjunction with the following drawing figures, wherein like numerals denote like elements, and wherein:

FIG. 1 shows a schematic of a primary latch mechanism.

FIG. 2 shows a detailed view of the primary latch mechanism of FIG. 1 in a locked state.

FIG. 3 shows a detailed view of the primary latch mechanism of FIG. 1 in an intermediate state.

FIG. 4 shows a detailed view of the primary latch mechanism of FIG. 1 in an unlocked state.

FIG. 5 shows a banknote processing device with a primary latch mechanism in a locked state and with a secondary latch mechanism in a locked state.

FIG. 6 shows the banknote processing device of FIG. 5 with the primary latch mechanism in a locked state and with the secondary latch mechanism in an unlocked state.

FIG. 7 shows the banknote processing device of FIG. 5 with the primary latch mechanism in an unlocked state and with the secondary latch mechanism in an unlocked state.

FIG. 8 shows the banknote processing device of FIG. 5 in an opened configuration.

### DETAILED DESCRIPTION OF EXEMPLARY EMBODIMENTS

The representations and illustrations in the drawings may be schematic and not to scale. A better understanding of the primary latch mechanism and the banknote processing device described above may be obtained through a review of the shown illustrations together with a review of the detailed description that follows. Throughout the Figures, same reference numerals denote the same or at least similar elements.

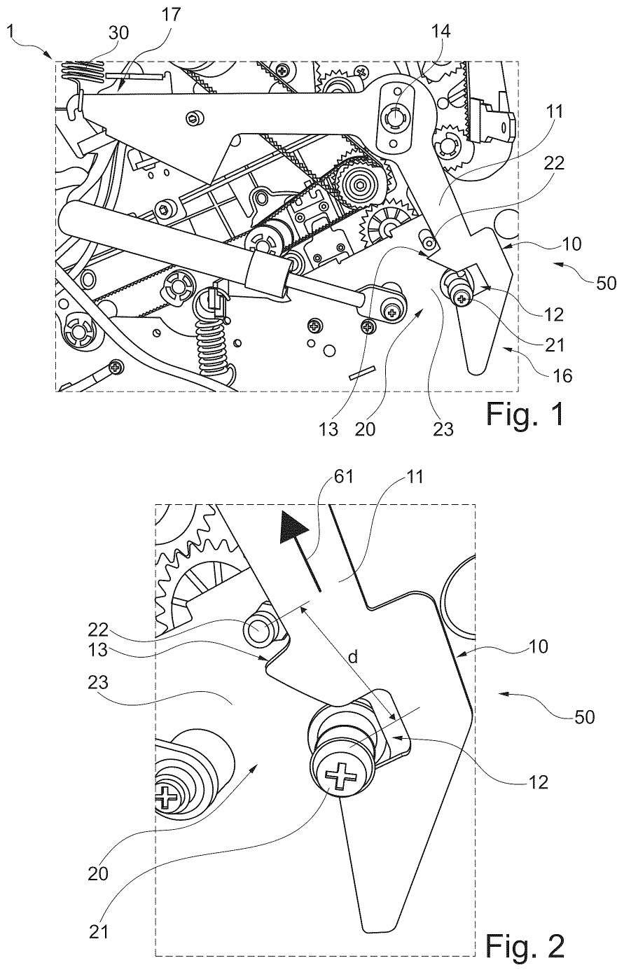

FIG. 1 shows a primary latch mechanism 1. The primary latch mechanism 1 comprises a first latch component 10 and a second latch component 20, wherein the first latch component 10 is configured to engage with or disengage from the second latch component 20 upon a movement of the first latch component 10 relative to the second latch component 20. The first latch component 10 comprises lever arm 11 having a recess 12 and a guide surface 13. The second latch component 20 comprises an engagement pin 21 and a guide pin 22. The lever arm 11 may be a longitudinal element extending between a first end 16 and a second end 17. The lever arm 11 may be rotatably coupled to a surrounding support structure, for example a first support structure of a banknote processing device into which the primary latch mechanism 1 can be integrated. Thus, the lever arm 11 can be rotated about a rotational axis 14. The recess 12 of the lever arm 12 may provide a hook-like structure at the first end 16 of the lever arm 11. In particular, the lever arm 11 may include an enlarged head portion at the first end 16 where the recess 12 is located. At the second end 17 of the lever arm 11, a biasing element 30 may bias the lever arm 11 to maintain a specified locking state 50 of the primary latch mechanism 1 in which the first latch component 10 is engaged with the second latch component 20. The guide surface 13 may be an outer surface of the head portion of the lever arm 11 that guides the movement of the lever arm 11 during a movement of the lever arm 11 relative to the second latch component 20. The second latch component 20 may comprise a carrier element 23, for example a plate or frame, on which the engagement pin 21 and the guide pin 22 are arranged.

FIG. 2 shows a detailed view of the primary latch mechanism 1 of FIG. 1 in the locked state 50. In particular, FIG. 2 shows a detailed view of the head portion of the lever arm 11 and the arrangement of the pins 21, 22 of the second latch component 20. As indicated above, the second latch component 20 may comprise the carrier element 23, e.g., a plate-like or frame-like structure, that is integrated into or forms part of a second support structure of the above-mentioned banknote processing device. The carrier element 23 includes the engagement pin 21 and the guide pin 22, both of which may protrude out of a flat surface of the carrier element 23 of the second latch component 20. In the locked state 50, the engagement pin 21 is located within the recess 12, i.e., the first latch component 10 is engaged with the second latch component 20. The engagement pin 21 may be movably arranged with respect to the carrier element 23 such that the engagement pin 21 can be pulled by the lever arm 11 towards the guide pin 22 when the lever arm 11 performs a first partial movement in a first movement direction 61 (indicated by an arrow in FIG. 2). The first partial movement preferably has a maximum of 3 mm. During this pulling, a distance d between the guide pin 22 and the engagement pin 21 may decrease. The first partial movement of the lever arm 11 may be an initial movement that allows the outer surface 13 of the lever arm 11 to establish a contact with the guide pin 22. In contrast to the engagement pin 21, the guide pin 22 may be fixedly arranged at the carrier element 23 of the second latch component 20.

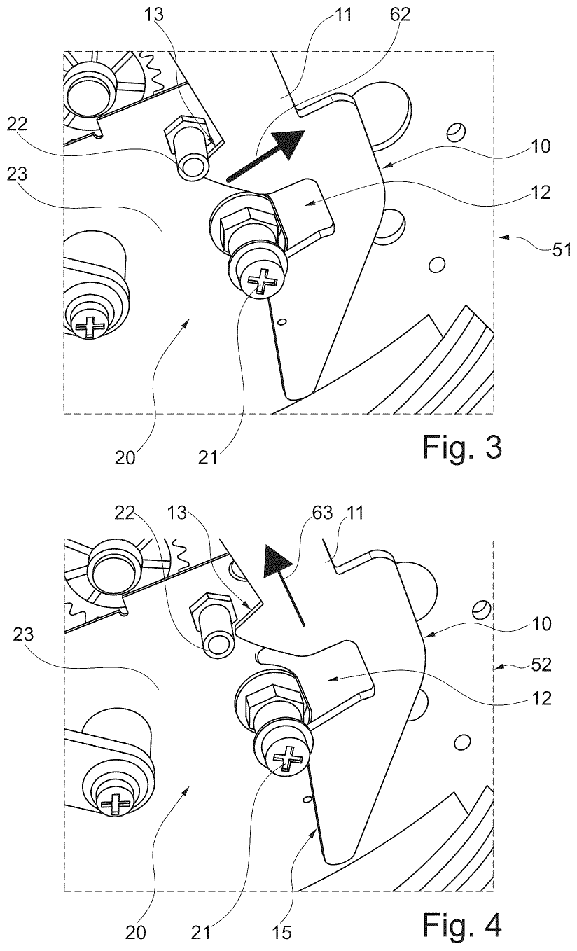

As can be seen from FIG. 3, after establishing the contact between the guide pin 22 and the guide surface 13, the guide surface 13 slides along the guide pin 22 according to a second partial movement in a second movement direction 62 (indicated by an arrow in FIG. 3). Thus, the head portion of the lever arm 11 can moved relative to the second latch component 20, e.g., relative to the carrier element 23, in the second movement direction 62. It is noted that FIG. 3 shows a detailed view of the primary latch mechanism 1 of FIG. 1 in an intermediate state 51 in which the lever arm 11 has been moved in the second movement direction 62. The corresponding second partial movement is generated by an urging of the head portion of the lever arm 11 away from the engagement pin 21 such that the engagement pin 23 is at least partially removed from the recess 12. The second partial movement thus occurs as a result of sliding the guide surface 13 along the guide pin 22. This sliding may be achieved by further pulling the lever arm 11 in the first movement direction 61 (cf. FIG. 2), while the guide pin 22 is already in contact with the guide surface 13, which pushes or urges the head portion of the lever arm 11 in the second movement direction 62. As can be derived from FIGS. 2 and 3, the guide surface 13 may be present in the form of a protrusion on the lever arm 11 that sidewardly protrudes out of the longitudinally shaped lever arm 11. The intermediate state 51 may define a state of the primary latch mechanism 1 where primary latch mechanism 1 is neither completely locked nor completely unlocked. The intermediate state 51 may be defined by any position of the lever arm 11 during the sliding along the guide pin 22.

FIG. 4 now shows a detailed view of the primary latch mechanism 1 of FIG. 1 in an unlocked state 52. This unlocked state 52 may be achieved after the lever arm 11 has been moved into the second movement direction 62 (cf. FIG. 3). In the unlocked state 52, the first latch component 10 is disengaged from the second latch component 20 since the lever arm 11 has moved to a position in which the engagement pin 21 of the second latch component 20 is not located in the recess 12 of the first latch component 10 anymore, i.e., the engagement pin 21 has been removed from the recess 12. Starting from the unlocked state 52, the lever arm 11 can be further moved according to a third partial movement, i.e., in a third movement direction 63 (indicated by an arrow in FIG. 4). During the movement in the third movement direction 63, another surface 15 at the head portion of the lever arm 11 can slide along the engagement pin 21. The guide surface 13 and the other surface 15 may be arranged at opposite sides with respect to the recess 12, but outside of the recess 12.

As can be seen from FIGS. 1 to 4, the lever arm 11 can be moved parallel with respect to the carrier element 23, wherein the movement of the lever arm 11 may be composed of translational and rotational movements. There may be a change in the movement direction between the first partial movement and second partial movement as well as between the second partial movement and third partial movement. In particular, FIGS. 2 to 4 show the movement sequence of the lever arm 11 relative to the carrier 23 element of the second latch component 20 in order to bring the primary latch mechanism 1 from the locked state 50, where the first latch component 10 is engaged with the second latch component 20, into the unlocked state 52, where the first latch component 10 is disengaged with the second latch component 20. In particular, the lever arm 11 is configured to move according to the first movement direction 61 during the first partial movement of the first latch component 10 relative to the second latch component 20 (cf. FIG. 2).

During the first partial movement, which can be a very short initial movement, the lever arm 11 may substantially move with a translational movement. Afterwards, the head portion of the lever arm 11 moves in the second movement direction 62 during the second partial movement of the first latch component 10 relative to the second latch component 20 (cf. FIG. 3). The transition between the first movement direction 61 and the second movement direction 62 is defined by the contact between the guide surface 13 and the guide pin 22, such that there is a change in the movement direction between the first and second partial movement. It is noted that the first partial movement may be defined by a movement between the first and second latch components 10, 20 which merely increases the pressure between the guide surface 13 and the guide pin 22. That is, in the locked state 50, the first partial movement might not occur in the form of a perceivable translational movement, but rather in the form of a stronger pressing of the guide surface 13 against the guide pin 22, which then urges the guide surface 13 to slide along the guide pin 22. During the second partial movement, the lever arm 11 may substantially move with a rotational movement. Afterwards, the lever arm 11 moves according to the third movement direction 63 during the third partial movement of the first latch component 10 relative to the second latch component 20 (cf. FIG. 4). Again, there may be a change in the movement direction between the second and third partial movement. During the third partial movement, the lever arm 11 may substantially move with a translational movement.

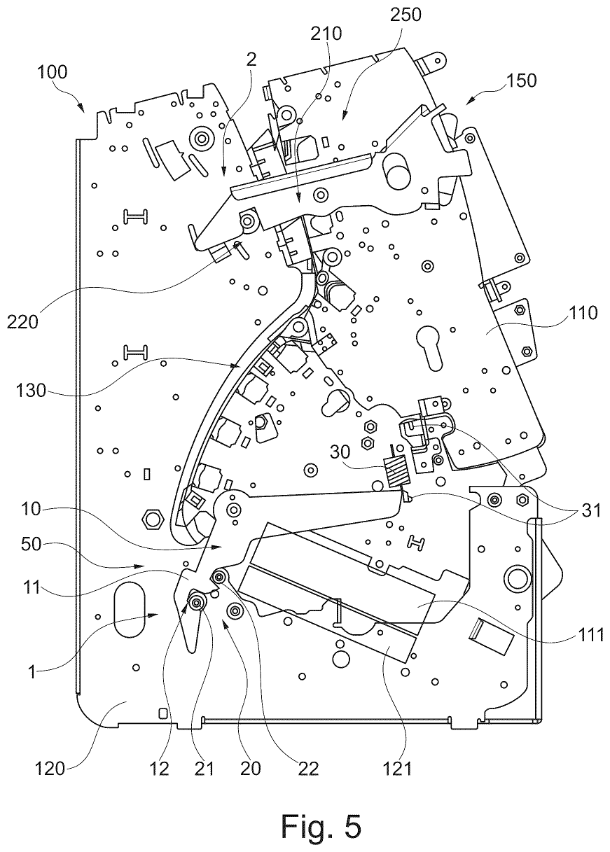

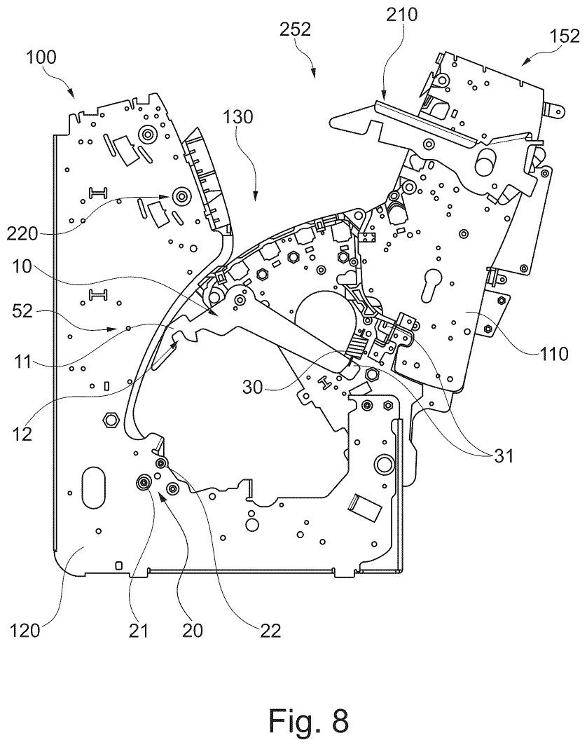

FIGS. 5 to 8 now show a banknote processing device 100, for example the above-mentioned banknote device into which the primary latch mechanism 1 of FIGS. 1 to 4 is integrated. FIG. 5 shows the primary latch mechanism 1 in the locked state 50. The banknote processing device 100 comprises a first support structure 110 and a second support structure 120, as it was already indicated above. The first support structure 110 and the second support structure 120 provide the two main components of the banknote processing device 100 and together define an internal space 130 in the form of a banknote transport path through which banknotes can be transported during operation of the banknote processing device 100. The first support structure 110 and the second support structure 120 are moveable relative to each other from a closed configuration 150 (illustrated in FIGS. 5 to 7) to an opened configuration 152 (illustrated in FIG. 8) in order to allow access to the internal space 130 of the banknote processing device 100. The first latch component 10 of the primary latch mechanism 1 is coupled to the first support structure 110 and the second latch component 20 of the primary latch mechanism 1 is coupled to the second support structure 120.

The banknote processing device 100 further comprises a secondary latch mechanism 2 that has a first latch component 210 and a second latch component 220, wherein the first latch component 210 of the secondary latch mechanism 2 is coupled to the first support structure 110 and the second latch component 220 of the secondary latch mechanism 2 is coupled to the second support structure 120. The biasing element 30 (cf. also FIG. 1) as well as corresponding mounting features 31 at the lever arm 11 and at the first support structure 110 are also shown in FIGS. 5 to 8.

In addition, a sensor arrangement including a first sensor 111 arranged at the first support structure 110 and a second sensor 121 arranged at the second support structure 120 are shown in FIGS. 5 to 7. These sensors 111, 121 may be configured to provide information about the banknotes moving through the transport path of the banknote processing device 100 during operation, when the banknote processing device 100 is in the closed configuration 150. The sensors 111, 121 may be arranged within respective sensor housings. In the closed configuration 150, the primary latch mechanism 1 and secondary latch mechanism 2 maintain defined distances or gaps between the first support structure 110 and the second support structure 120, such that the sensors 111, 121 also maintain defined distances or gaps between each other, which enables the sensors 111, 121 to acquire accurate and reproducible information.

FIG. 5 shows a configuration where the primary latch mechanism 1 is in the locked state 50 and the secondary latch mechanism 2 is in a locked state 250. The latch components 10, 20 of the primary latch mechanism 1 are engaged with each other and the latch components 210, 220 of the secondary latch mechanism 2 are also engaged with each other. In this configuration, the first support structure 110 and the second support structure 120 are in the closed configuration 150, wherein the banknote processing device 100 is closed, i.e., the banknote processing device 100 is in its operational state. In this operational state, a distance or gap between the housing of the first sensor 111 and the housing of the second sensor 121 is about 0.2 Millimeters.

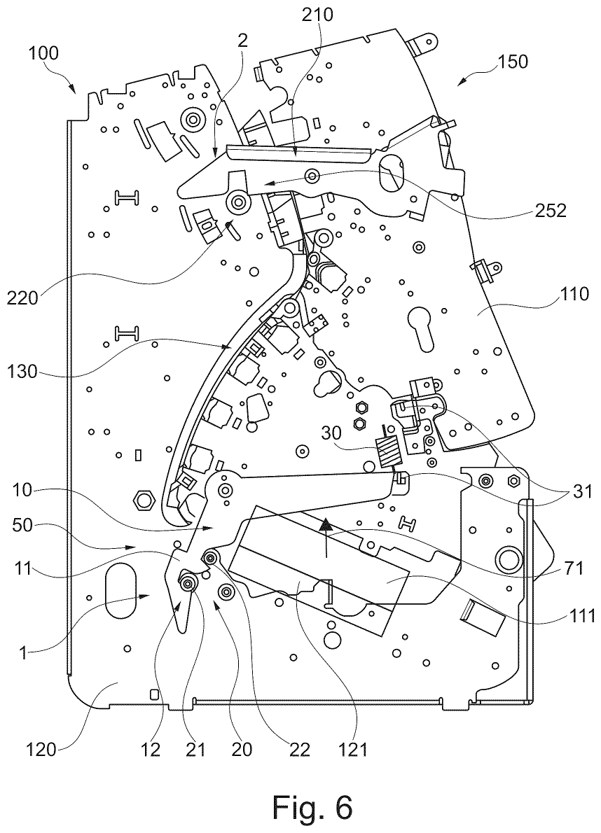

FIG. 6 shows a configuration where the first latch component 210 of the secondary latch mechanism 2 is disengaged from the second latch component 220 of the secondary latch mechanism 2, wherein the first latch component 10 of the primary latch mechanism 1 is still engaged with the second latch component 20 of the primary latch mechanism 1. In other words, the primary latch mechanism 1 is still in its locked state 50, while the secondary latch mechanism 2 is in its unlocked state 252. In the configuration shown in FIG. 6, the distance or gap between the housing of the first sensor 111 and the housing of the second sensor 121 is about 1 Millimeter. At this stage of the unlocking process, the housing of the second sensor 121 may be moved upwardly for about 3 Millimeters in a vertical direction 71 of the banknote processing device 100 as the secondary latch mechanism 2 gets unlocked and the housing of the first sensor 111 starts to rotate about a pivot axis where the first support structure 110 is pivotably coupled with respect to the second support structure 120. The housing of the second sensor 121 may be spring loaded to help initiating the above-described first partial movement of the first latch component 10 relative to the second latch component 20 of the primary latch mechanism 1. At this point in time, the guide surface 13 may start to slide along the guide pin 22 (cf. also FIG. 3).

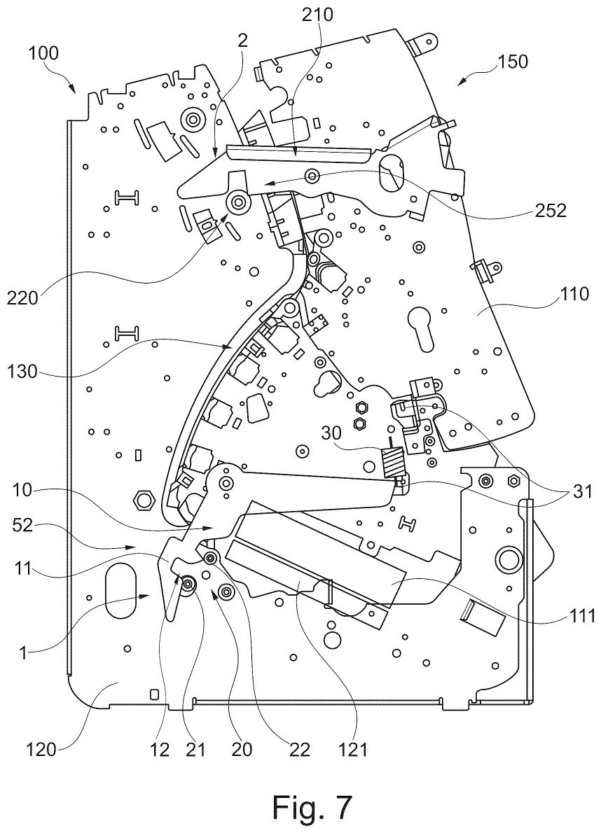

FIG. 7 shows a configuration where the first latch component 210 of the secondary latch mechanism 2 is disengaged from the second latch component 220 of the secondary latch mechanism 2, and also the first latch component 10 of the primary latch mechanism 1 is disengaged from the second latch component 20 of the primary latch mechanism 1. In other words, the primary latch mechanism 1 is now in its unlocked state 52, and also the secondary latch mechanism 2 is in its unlocked state 252. In this configuration, the first support structure 110 can be further pivoted relative to the second support structure 120, which further helps disengaging of the first latch component 10 from the second latch component 20 of the primary latch mechanism 1. At this stage of the unlocking process, the housing of the first sensor 111 may be rotated approximately 4.5 degrees with respect to the housing of the second sensor 121. Now, the housing of the second sensor 121 may again be moved for about 3 Millimeters in the vertical direction 71 of the banknote processing device 100. The first latch component 10 can then move away from the engagement pin 22 and, thus, the first latch component 10 will be disengaged from the second latch component 20.

FIG. 8 shows a configuration where the primary latch mechanism 1 is in its unlocked state 52, and also the secondary latch mechanism 2 is in its unlocked state 252, and where first support structure 110 has been pivoted with respect to the second support structure 120 such that an access to the internal space 130 of the banknote processing device 100, e.g., to the banknote transport path, is provided. In this completely opened configuration, an operator can easily access the internal space 130 of the banknote processing device 100 for maintenance purposes.

1.-15. (canceled)

16. A primary latch mechanism for a banknote processing device, comprising:
a first latch component;
a second latch component;
wherein the first latch component is configured to engage with the second latch component upon a movement of the first latch component relative to the second latch component;
wherein the first latch component comprises lever arm having a recess and a guide surface;
wherein the second latch component comprises an engagement pin and a guide pin;
wherein the recess is configured to receive the engagement pin, thereby providing a locked state of the primary latch mechanism in which the first latch component is engaged with the second latch component;
wherein the guide surface is configured to establish a contact with the guide pin upon a first partial movement of the first latch component relative to the second latch component;
wherein the guide surface is configured to slide along the guide pin during a second partial movement of the first latch component relative to the second latch component such that the engagement pin is at least partially removed from the recess, thereby providing an unlocked state of the primary latch mechanism in which the first latch component is disengaged from the second latch component.

17. The primary latch mechanism according to claim 16, wherein the engagement pin is movably arranged at the second latch component such that a distance between the engagement pin and the guide pin is reduced during the first partial movement of the first latch component relative to the second latch component.

18. The primary latch mechanism according to claim 16, wherein the guide pin is arranged relative to the guide surface such that a movement direction of the lever arm changes when the contact between the guide surface and the guide pin is established.

19. The primary latch mechanism according to claim 16, wherein the lever arm is configured to move according to a first movement direction during the first partial movement of the first latch component relative to the second latch component;
wherein the lever arm configured to move according to a second movement direction during the second partial movement of the first latch component relative to the second latch component;
wherein the first movement direction differs from the second movement direction.

20. The primary latch mechanism according to claim 16, wherein the lever arm is rotatable about a rotational axis of the lever arm;
wherein the lever arm is configured to rotate about the rotational axis of the lever arm during the second partial movement of the first latch component relative to the second latch component.

21. The primary latch mechanism according to claim 16, wherein the lever arm is configured slide along the engagement pin in a third movement direction during a third partial movement of the first latch component relative to the second latch component such that the recess is spatially separated from the engagement pin.

22. The primary latch mechanism according to claim 16, wherein the second latch component comprises a carrier element to which the engagement pin is movably coupled and/or to which the guide pin is fixedly coupled.

23. The primary latch mechanism according to claim 22, wherein the lever arm is translationally movable with respect to the carrier element of the second latch component; and/or
wherein the lever arm is rotationally movable with respect to the carrier element of the second latch component.

24. The primary latch mechanism according to claim 16, comprising:
a biasing element configured to maintain the locked state of the primary latch mechanism in which the first latch component is engaged with the second latch component.

25. A banknote processing device, comprising:
the primary latch mechanism according to claim 16;
a first support structure and a second support structure;
wherein the first support structure and the second support structure together define an internal space of the banknote processing device;
wherein the first support structure and the second support structure are moveable relative to each other from a closed configuration to an opened configuration in order to allow access to the internal space of the banknote processing device;
wherein the first latch component of the primary latch mechanism is coupled to the first support structure;
wherein the second latch component of the primary latch mechanism is coupled to the second support structure.

26. The banknote processing device according to claim 25, wherein the first support structure and the second support structure are moveable relative to each other from the closed configuration to the opened configuration when the primary latch mechanism is in the unlocked state.

27. The banknote processing device according to claim 25, wherein the internal space defines a banknote transport path for banknotes processed by the banknote processing device.

28. The banknote processing device according to claim 25, comprising:
a first sensor arranged at the first support structure;
a second sensor arranged at the second support structure.

29. The banknote processing device according to claim 25, comprising:
a secondary latch mechanism having a first latch component and a second latch component;
wherein the first latch component of the secondary latch mechanism is coupled to the first support structure;
wherein the second latch component of the secondary latch mechanism is coupled to the second support structure.

30. The banknote processing device according to claim 29, wherein the first support structure and the second support structure are moveable relative to each other from the closed configuration to the opened configuration when the secondary latch mechanism is in an unlocked state.
